(19) United States
(12) Patent Application Publication
(10) Pub. No.: US 2024/0094818 A1
(43) Pub. Date: Mar. 21, 2024

(54) TACTILE SENSE EFFECT MANAGEMENT METHOD AND APPARATUS, ELECTRONIC DEVICE AND MEDIUM

(71) Applicant: AAC Acoustic Technologies (Shanghai)Co., Ltd., Shanghai (CN)

(72) Inventor: Xueni Cao, Shenzhen (CN)

(21) Appl. No.: 18/090,527

(22) Filed: Dec. 29, 2022

Related U.S. Application Data
(63) Continuation of application No. PCT/CN2022/126356, filed on Oct. 20, 2022.

(30) Foreign Application Priority Data
Sep. 20, 2022 (CN) 202211140387.1

(51) Int. Cl. G06F 3/01; G06F 3/041

(52) U.S. Cl. CPC G06F 3/016; G06F 3/0414

(57) ABSTRACT

The present invention provide a tactile sense effect management method, apparatus, electronic device and medium, the method including: storing tactile sense effect style information, the tactile sense effect style information including: a first basic style category corresponding to a first factor and a stylized basic element for providing a tactile sense effect under the first basic style category; the first factor is an influencing factor used for generating tactile sense effects of different categories of styles; and performing a reading operation on the tactile sense effect style information or performing a writing operation on the tactile sense effect style information. The present invention can classify and manage the tactile sense effect style.

### CROSS-REFERENCE TO RELATED APPLICATIONS

The application is a continuation of International Application No. PCT/CN2022/126356 filed on Oct. 20, 2022, which is incorporated herein by reference in its entireties.

### TECHNICAL FIELD

The present invention relates to the technical field of electronic devices, in particular, to a tactile sense effect management method and apparatus, an electronic device and a medium.

### BACKGROUND

Different tactile sense effects can bring different feelings to people. With the gradual popularization and application of tactile sense effects, it is necessary to provide a tactile sense effect management method.

### SUMMARY

The present invention aims to provide a tactile sense effect management method and apparatus, an electronic device and a medium.

The technical solution of the present invention is as follows: in a first aspect, an embodiment of the present invention provides a tactile sense effect management method, including: storing tactile sense effect style information, the tactile sense effect style information including: a first basic style category corresponding to a first factor and a stylized basic element for providing a tactile sense effect under the first basic style category; wherein the first factor is an influencing factor used for generating tactile sense effects of different categories of styles; and performing a reading operation on the tactile sense effect style information or performing a writing operation on the tactile sense effect style information.

Optionally, the tactile sense effect style information further includes other basic style categories corresponding to the first factor; the step of storing tactile sense effect style information includes: storing various basic style categories corresponding to the first factor as one subset of a basic style category set in the tactile sense effect style information; and storing stylized basic elements under various basic style categories corresponding to the first factor as one subset of a stylized basic element set in the tactile sense effect style information.

Optionally, the tactile sense effect style information further includes: a second basic style category corresponding to the first factor, one or more combined style categories obtained by correspondingly combining the first basic style category with the second basic style category in one or more ratios, and stylized basic elements under the combined style categories; the step of storing tactile sense effect style information includes: storing the combined style categories obtained by combining at least two basic style categories corresponding to the first factor as one subset of a combined style category set in the tactile sense effect style information; and storing stylized basic elements under the combined style categories obtained by combining at least two basic style categories corresponding to the first factor as one subset of a combined stylized basic element set in the tactile sense effect style information.

Optionally, the step of performing a writing operation on the tactile sense effect style information includes: generating, according to configuration information of a third basic style category, a stylized basic element corresponding to the configuration information, the third basic style category being any basic style category in the tactile sense effect style information; and storing the stylized basic element corresponding to the configuration information to the third basic style category.

Optionally, the step of the performing a reading operation on the tactile sense effect style information includes: acquiring, according to a screening condition, a stylized basic element in the tactile sense effect style information satisfying the screening condition; wherein the screening condition includes at least one of an identifier of the basic style category in the tactile sense effect style information, an identifier of the stylized basic element in the tactile sense effect style information, an identifier of the subset in the tactile sense effect style information, scenario information corresponding to the basic style category in the tactile sense effect style information, and scenario information corresponding to the stylized basic element in the tactile sense effect style information.

Optionally, the screening condition includes the scenario information; the acquiring, according to a screening condition, the step of a stylized basic element in the tactile sense effect style information satisfying the screening condition includes: acquiring, according to the scenario information in the screening condition, a first stylized basic element in the tactile sense effect style information; and adjusting the first stylized basic element according to adjustment information of the first stylized basic element to obtain a second stylized basic element.

Optionally, the screening condition includes the scenario information; the acquiring, according to a screening condition, the step of a stylized basic element in the tactile sense effect style information satisfying the screening condition includes: acquiring, according to the scenario information in the screening condition, a first stylized basic element in the tactile sense effect style information; and displaying a tactile sense effect according to the first stylized basic element.

In a second aspect, an embodiment of the present invention provides a tactile sense effect management apparatus, including: a storage module, configured to store tactile sense effect style information, the tactile sense effect style information including: a first basic style category corresponding to a first factor and a stylized basic element for providing a tactile sense effect under the first basic style category; wherein the first factor is an influencing factor used for generating tactile sense effects of different categories of styles; and a processing module, configured to perform a reading operation on the tactile sense effect style information or performing a writing operation on the tactile sense effect style information.

In a third aspect, an embodiment of the present invention provides an electronic device, the electronic device including a memory configured to store computer program instructions, a processor configured to execute the computer program instructions, and a communication apparatus, wherein the computer program instructions, when executed by the processor, trigger the electronic device to perform the method according to any one of the first aspect.

In a fourth aspect, an embodiment of the present invention provides a computer-readable storage medium, wherein the computer-readable storage medium stores computer programs; and the computer programs, when run on a computer, cause the computer to perform the method according to any one of the first aspect.

The beneficial effects of the present invention lie in: the tactile sense effect style is classified and managed.

### BRIEF DESCRIPTION OF THE DRAWINGS

FIG. 1 is a flow chart of a tactile sense effect management method provided according to one embodiment of the present invention;

FIG. 2 is a schematic diagram of a basic style category for dividing tactile sense effects provided according to one embodiment of the present invention;

FIG. 3 is a schematic block diagram of a tactile sense effect management apparatus provided according to one embodiment of the present invention; and

FIG. 4 is a schematic structural diagram of a computer device provided by one embodiment of the present invention.

### DETAILED DESCRIPTION OF THE EMBODIMENTS

The present invention is further described below in combination with the accompanying drawings and implementations.

It should be understood that the described embodiments are merely a part of the embodiments of the present invention and not all embodiments. The singular forms of “a”, “said”, and “the” used in the embodiments of the present invention and the claims are also intended to include plural forms, unless the context clearly indicates other meanings.

It should be understood that the term “multiple” herein means two or more, “plurality of” means two or more than two. The term “and/or” herein is only an association relationship that describes associated objects, and represents that there can be three relationships. For example, A and/or B can represent that: A exists alone, A and B exist simultaneously, and B exists alone. In addition, the character “/” herein generally indicates that the front and back associated objects are in an “or” relationship. “At least one of the following” and similar expressions means any combination of such terms, including any combination of monomeric or complex terms. For example, at least one of a,b, and c may represent: a,b,c, A-b, A-c, B-c, or A-B-C, where a,b, and c may be single or multiple.

It should be understood that although the terms first, second, etc. may be used to describe set thresholds in the present invention, these set thresholds should not be limited to these terms. These terms are used only to distinguish set thresholds from each other. For example, the first set threshold may also be referred to as the second set threshold, and similarly the second set threshold may be referred to as the first set threshold, provided that it is not outside the scope of the embodiment of the present invention.

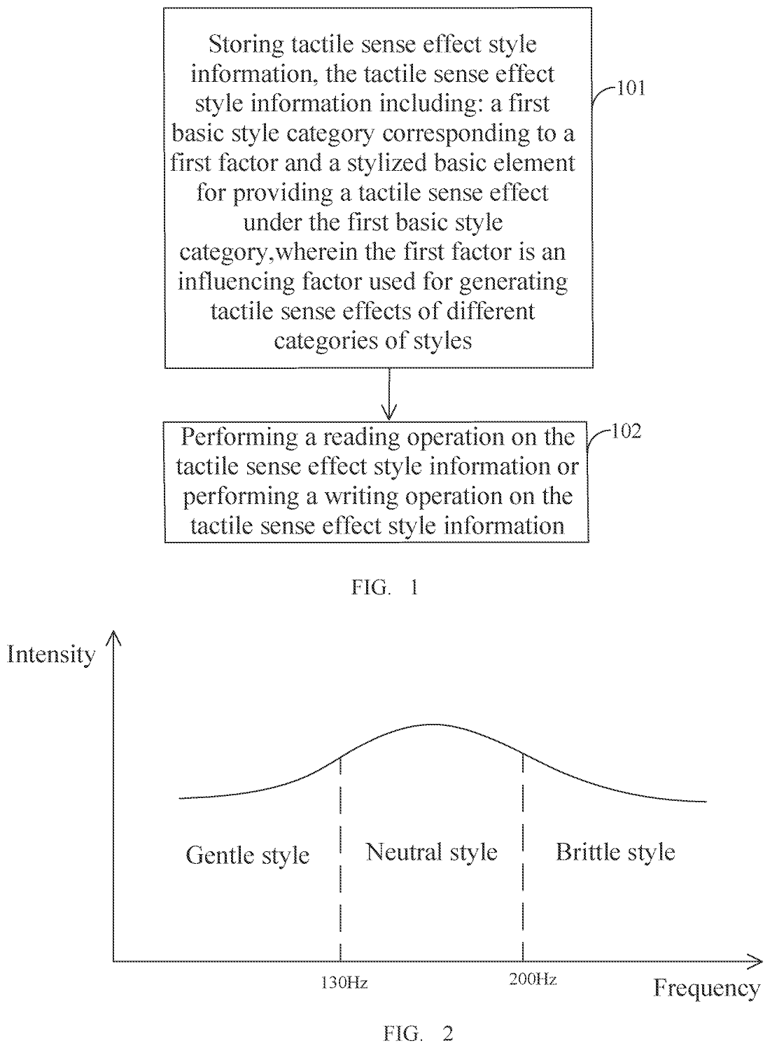

Referring to FIG. 1, one embodiment of the present invention provides a tactile sense effect management method. The method may include the following step 101 and step 102. An executive body of the method shown in FIG. 1 is an electronic device.

Step 101, storing tactile sense effect style information, the tactile sense effect style information including: a first basic style category corresponding to a first factor and a stylized basic element for providing a tactile sense effect under the first basic style category, wherein the first factor is an influencing factor used for generating tactile sense effects of different categories of styles.

Considering that vibrations under different vibration frequencies (referred to as frequency), single vibration durations (or one-time vibration durations, referred to as duration) and vibration intensities (referred to as intensity) and their different combinations can generate vibration tactile senses of different styles, which can bring people different feelings. In one embodiment, the first factor included in the tactile sense effect style information includes any one or more of a frequency, a duration, and an intensity.

The tactile sense effect style information may include one or more basic style categories corresponding to the first factor, and one or more stylized basic elements under the various basic style categories.

The various basic style categories corresponding to the first factor can be divided according to a numerical value of the first factor.

The stylized basic elements under the basic style categories can be configuration information of tactile sense effects. When a tactile sense effect is displayed according to the configuration information, the corresponding tactile sense effect can be displayed.

The stylized basic elements under the basic style categories can also be signals of tactile sense effects. The signal of a tactile sense effect can be output to show the corresponding tactile sense effect.

FIG. 2 is a schematic diagram of a basic style category for dividing tactile sense effects. Referring to FIG. 2, a frequency serving as the first factor is taken as an example. There may be three basic style categories of corresponding frequencies according to different frequency values, including, for example, a gentle style category corresponding to a low-frequency (for example, the frequency is less than 130 Hz) vibration tactile sense, a neutral style category corresponding to a medium-frequency (for example, the frequency is between 130 Hz and 200 Hz) vibration tactile sense, and a brittle style category corresponding to a high-frequency (for example, the frequency is greater than 200 Hz) vibration tactile sense.

A duration serving as the first factor is taken as an example. There may be two basic style categories of corresponding durations according to different duration values, including, for example, a concise style category corresponding to a short-duration vibration tactile sense and a prolix style category corresponding to a long-duration vibration tactile sense.

Referring to the following table 1, table 1 shows the stylized basic elements under the three basic style categories corresponding to frequencies.

TABLE 1

| Gentle style element | Neutral style element | Brittle style element |
|---|---|---|
| Short gentle tactile sense effect | Short neutral tactile sense effect | Short brittle tactile sense effect |
| Long gentle tactile sense effect | Long neutral tactile sense effect | Long brittle tactile sense effect |
| Combined gentle tactile sense | Combined neutral tactile sense | Combined brittle tactile sense |
| effect | effect | effect |

In table 1, the gentle style element is a stylized basic element under the gentle style category. The gentle style element may include three kinds of different stylized basic elements, including a short gentle tactile sense effect, a long gentle tactile sense effect, and a combined gentle tactile sense effect. The combined gentle tactile sense effect includes a short gentle tactile sense effect and a long gentle tactile sense effect.

In table 1, the neutral style element is a stylized basic element under the neutral style category. The neutral style element may include three kinds of different stylized basic elements, including a short neutral tactile sense effect, a long neutral tactile sense effect, and a combined neutral tactile sense effect. The combined neutral tactile sense effect includes a short neutral tactile sense effect and a long neutral tactile sense effect.

In table 1, the brittle style element is a stylized basic element under the brittle style category. The brittle style element may include three kinds of different stylized basic elements, including a short brittle tactile sense effect, a long brittle tactile sense effect, and a combined brittle tactile sense effect. The combined brittle tactile sense effect includes a short brittle tactile sense effect and a long brittle tactile sense effect.

The stylized basic element corresponding to “short effect” in table 1 is a short signal. The stylized basic element corresponding to “long effect” in table 1 is a long signal. The short signal and the long signal are different types of signals. The stylized basic element corresponding to “combined effect” in table 1 is a signal combination. The signal combination simultaneously includes a long signal and a short signal under the same basic style category.

The short signal can be a signal that is pre-generated according to the performance of a motor and on the basis of an algorithm. A signal has a fixed duration and only has several optional fixed frequencies. Based on this, a tactile sense stylist or a user can pick a signal with an appropriate frequency and adjust the intensity, thus obtaining a corresponding short signal. Differing from the short signal, a long signal can be a signal that is obtained by editing a duration, a frequency or an intensity by the tactile sense stylist or the user at a will.

By means of executing step 101, the designed tactile sense effect style information can be stored in a storage module of the electronic device. For example, the tactile sense effect style information can be stored into a tactile sense effect library of the electronic device.

The embodiment shown in FIG. 1 can define a tactile sense effect style, and provides a tactile sense effect classification logic based on correlations among factors, basic style categories and stylized basic elements. Good classification management for tactile sense effect styles can be achieved on the basis of the tactile sense effect classification logic.

The tactile sense effect style information further includes other basic style category corresponding to the first factor. Correspondingly, the step of storing tactile sense effect style information may include: storing various basic style categories corresponding to the first factor as one subset of a basic style category set in the tactile sense effect style information; and storing stylized basic elements under various basic style categories corresponding to the first factor as one subset of a stylized basic element set in the tactile sense effect style information.

In order to perform stylized definition on a tactile sense effect, a basic style category set L and a stylized basic element set P can be defined. L can be a set composed of all the basic style categories, and P can be a set composed of the stylized basic elements under all the basic style categories.

For example, L may at least include the three basic style categories: “gentle style category, neutral style category and brittle style category” shown in FIG. 2. The three basic style categories can be used as one subset of L if they all correspond to a factor, i.e. frequency.

In addition, L may also include the two basic style categories: “concise style category and prolix style category”. The two basic style categories can be used as one subset of L if they all correspond to a factor, i.e. duration.

For example, P may at least include the nine kinds of stylized basic elements, i.e. “gentle short tactile sense effect, gentle long tactile sense effect, gentle combined tactile sense effect, neutral short tactile sense effect, neutral long tactile sense effect, neutral combined tactile sense effect, brittle short tactile sense effect, brittle long tactile sense effect, and brittle combined tactile sense effect” shown in table 1. The nine kinds of stylized basic elements can be used as one subset of P if they all correspond to the stylized basic element under the basic style categories corresponding to the frequency.

The tactile sense effect style information is divided into subsets according to the tactile sense effect classification logic. Each subset can be one style category. After the style classification, users can manage and search tactile sense effects in the tactile sense effect style information, so that inexperienced users can also quickly screen out and find desired tactile sense effects from the stored tactile sense effect style information through the style classification.

After the basic style category corresponding to the first factor is obtained according to the first factor, the basic style category corresponding to the first factor can also be extended, so as to extend the styles of the tactile sense effects.

The tactile sense effect style information further includes: a second basic style category corresponding to the first factor, one or more combined style categories obtained by correspondingly combining the first basic style category with the second basic style category in one or more ratios, and stylized basic elements under the combined style categories.

The step of storing tactile sense effect style information may include: storing the combined style categories obtained by combining at least two basic style categories corresponding to the first factor as one subset of a combined style category set in the tactile sense effect style information; and storing stylized basic elements under the combined style categories obtained by combining at least two basic style categories corresponding to the first factor as one subset of a combined stylized basic element set in the tactile sense effect style information.

New style categories can be obtained by combining the various basic style categories corresponding to the first factor. If the obtained new style category is a combined style category, it indicates that the new style category is obtained by combining the various basic style category corresponding to the first factor. Stylized basic elements under the combined style category can be obtained according to the obtained combined style category.

Different combined style categories can be obtained by combination by means of changing the kinds of the basic style categories.

For example, the gentle style categories and the neutral style categories can be combined in a certain ratio (for example, ratio 1) to obtain a combined soothing style category, and the brittle style categories and the neutral style categories can be combined in a certain ratio (for example, ratio 1) to obtain a combined clear style category.

Different combined style categories can be obtained by combination by means of changing the ratios of the basic style categories in the combinations.

The ratio can be a ratio of a basic style category in a combination. A ratio can be calculated according to durations of tactile sense effect signals of various basic style categories in a combination. In another embodiment, a ratio can be calculated according to the number of tactile sense effect signals of various basic style categories in a combination.

For example, the brittle style categories and the neutral style categories are combined respectively in different ratios (for example, ratio 1, ratio 2 and ratio 3), so that a combined clear style category, happy style category and bright style category can be correspondingly combined.

Different combined style categories can be obtained by combination by means of changing the kinds and ratios of the basic style categories.

For example, the gentle style categories and the neutral style categories can be combined in a certain ratio (for example, ratio 1) to obtain a combined soothing style category, and the brittle style categories and the neutral style categories can be combined in a certain ratio (for example, ratio 2) to obtain a combined happy style category.

Since new style categories are generated after the basic style categories corresponding to the first factor are combined, sets of style categories change. In order to perform the stylized definition on the tactile sense effects, a combined style category set L′ and a combined stylized basic element set P′ can be defined. L′ can be a set composed of all combined style categories, and P′ can be a set composed of stylized basic elements under all the combined style categories.

For example, L′ may at least include various combined style categories obtained according to the three basic style categories: “gentle style category, neutral style category and brittle style category” corresponding to frequency. The various combined style categories can be used as one subset of L′.

For example, L′ may at least include stylized basic elements under various combined style categories obtained according to the three basic style categories: “gentle style category, neutral style category and brittle style category” corresponding to frequency. The stylized basic elements under the various combined style categories can be used as one subset of P′.

For any two of the combined style categories in any one subset of L′, the basic style categories constituting the two combined style categories are different, and/or, the ratios of the basic style categories constituting the two combined style categories in the combinations are different, so that the two combined style categories are different.

Based on the definition of a tactile sense effect style and the tactile sense effect classification logic based on the correlations among factors, style categories and stylized basic elements, the problem in classification and management of tactile sense effects can be effectively solved, and the application and popularization of the tactile sense effects can also be pushed.

After the stylized classification is performed on the tactile sense effects, a specific tactile sense effect can be found more conveniently, and the tactile sense effect can be updated and deleted on demand.

The definition of a tactile sense effect style and the tactile sense effect classification logic can be opened to users, so that more users can participate in the tactile sense design. Based on the definition of a tactile sense effect style and the tactile sense effect classification logic, users lacking the tactile sense design experience and hardly independently designing tactile sense signals can also quickly screen and select desired tactile sense effects, so that it is conductive to applying tactile sense effect products of different industries and fields and pushing the generalization of tactile senses.

In order to achieve the objective of screening the tactile sense effects, a reading operation can be performed on the tactile sense effect style information. In another embodiment, in order to achieve the objective of designing the tactile sense effects, a writing operation can be performed on the tactile sense effect style information.

Step 102, performing a reading operation on the tactile sense effect style information or performing a writing operation on the tactile sense effect style information.

On the basis of the stored tactile sense effect style information, the reading operation can be performed on the tactile sense effect style information, so as to read the existing tactile sense effect style information. For example, any one of the existing stylized basic elements is read. The writing operation can be performed on the tactile sense effect style information, so as to write newly designed tactile sense effect style information. For example, newly designed stylized basic elements are written. The reading operation and the writing operation can be performed on the tactile sense effect style information on the basis of the tactile sense effect classification logic.

The step of performing a writing operation on the tactile sense effect style information may include: generating, according to configuration information of a third basic style category, a stylized basic element corresponding to the configuration information, the third basic style category being any basic style category in the tactile sense effect style information; and storing the stylized basic element corresponding to the configuration information to the third basic style category.

For example, when a user needs to design a tactile sense effect of a gentle style, configuration information of a gentle style category can be input, and a corresponding stylized basic element can be generated according to the configuration information; and the generated stylized basic element is stored to the gentle style category. It can be seen that the design and the classification and filing management of the tactile sense effects can be achieved on the basis of the tactile sense effect classification logic.

On the basis of the stored tactile sense effect style information, the stylized basic elements under the basic style categories can be designed, and the stylized basic elements under the combined style categories can also be designed.

The step of performing a writing operation on the tactile sense effect style information may include: generating, according to configuration information of any one combined style category in the tactile sense effect style information, a stylized basic element corresponding to the configuration information, and storing the stylized basic element corresponding to the configuration information to the combined style category.

The step of performing a reading operation on the tactile sense effect style information includes: acquiring, according to a screening condition, a stylized basic element in the tactile sense effect style information satisfying the screening condition; wherein the screening condition includes at least one of an identifier of the basic style category in the tactile sense effect style information, an identifier of the stylized basic element in the tactile sense effect style information, an identifier of the subset in the tactile sense effect style information, scenario information corresponding to the basic style category in the tactile sense effect style information, and scenario information corresponding to the stylized basic element in the tactile sense effect style information.

The screening condition may include the identifier of the basic style category. As such, the various stylized basic elements under the corresponding basic style category can be quickly screened out according to the identifier of the basic style category. A corresponding tactile sense effect can be displayed according to the obtained stylized basic element.

The screening condition may include the identifier of the stylized basic element. As such, the corresponding stylized basic element can be quickly screened out according to the identifier of the stylized basic element.

The screening condition may include the identifier of the basic style category and the identifier of the stylized basic element. As such, primary screening can be first performed according to the identifier of the basic style category, so as to preliminarily screen out the various stylized basic elements under the corresponding basic style category. Secondary screening is then performed according to the identifiers of the stylized basic elements, so as to quickly screen out a desired stylized basic element from the found stylized basic elements. Based on this tactile sense effect library classification and screening mechanism, tactile sense effects can be accurately and quickly screened.

The identifier of the stylized basic element may include an element category, including, such as, a long signal, a short signal, and a combined signal.

The screening condition may include the identifier of the subset in the tactile sense effect style information. As such, contents in the subset can be screened out according to the identifier of the subset.

The subset can be a subset of the basic style category set L, a subset of the combined style category set a subset of the stylized basic element set P, or a subset of the combined stylized basic element set P′.

Any subset can correspond to a corresponding classification label. The identifier of the subset may include a classification label corresponding to the subset. The tactile sense effect library may store the subset and the classification label of the subset, so that the corresponding subset can be found according to the classification label, so as to achieve the objective of searching and using the contents in the subset.

The screening condition may include the scenario corresponding to the basic style category. As such, the stylized basic element under the corresponding basic style category can be screened out according to the scenario information.

The screening condition may include the scenario corresponding to the stylized basic element. As such, the corresponding stylized basic element can be screened out according to the scenario information.

The screening condition may also include at least one of an identifier of the combined style category in the tactile sense effect style information and scenario information corresponding to the combined style category in the tactile sense effect style information.

Other embodiments also include screening conditions in other forms in addition to the screening conditions shown above. For example, the screening condition includes an identifier of one subset in the basic style category set and an identifier of the stylized basic element. This embodiment does not make restrictions on it.

After the stylized basic element is screened out, the screened out stylized basic element can be adjusted to generate a new stylized basic element. The new stylized basic element is used for providing a new tactile sense effect. As such, search and reapplication of the tactile sense effect can be achieved.

After the stylized basic element is screened out, a tactile sense effect can be displayed according to the screened out stylized basic element. As such, search and effect experience of the tactile sense effect can be achieved.

After the stylized basic element is screened out, a tactile sense effect can be first displayed according to the screened out stylized basic element, and the screened out stylized basic element is then adjusted to generate a new stylized basic element.

The screening condition of the present invention includes the scenario information. Correspondingly, the step of acquiring, according to a screening condition, a stylized basic element in the tactile sense effect style information satisfying the screening condition may include: acquiring, according to the scenario information in the screening condition, a first stylized basic element in the tactile sense effect style information; and adjusting the first stylized basic element according to adjustment information of the first stylized basic element to obtain a second stylized basic element.

The basic style category, the combined style category and the stylized basic element may all correspond to corresponding scenario information. The corresponding scenario information can be used as style category labels, so that the stylized basic element conforming to a scenario can be quickly and accurately screened out according to the scenario information.

For example, when the stylist needs to add a tactile sense effect to a breezing scenario, an analysis result of a need of creating a gentle feeling for the scenario is obtained by comprehensive analysis according to the scenario information of the scenario.

An analysis result which indicates that the scenario information corresponds to the gentle style category is taken as an example. The stylized basic element under the gentle style category can be acquired according to the analysis result. An analysis result which indicates that the scenario information corresponds to a certain stylized basic element under the gentle style category is taken as an example. The stylized basic element can be acquired according to the analysis result.

The stylist can adjust any of the acquired stylized basic element. By means of the adjustment, an adjusted new stylized basic element can be obtained, thus obtaining a new tactile sense effect.

The stylist can directly adjust the acquired stylized basic element. In another implementation, a tactile sense effect can also be displayed first according to the acquired stylized basic element. The stylist can decide, by means of experiencing the tactile sense effect, on demand whether to adjust the displayed tactile sense effect.

The screening condition includes the scenario information. Correspondingly, the step of acquiring, according to a screening condition, a stylized basic element in the tactile sense effect style information satisfying the screening condition may include: acquiring, according to the scenario information in the screening condition, a first stylized basic element in the tactile sense effect style information; and displaying a tactile sense effect according to the first stylized basic element.

After the stylized basic element is screened out, the tactile sense effect can be displayed, so that a user can intuitively experience the displayed tactile sense effect to determine whether the existing tactile sense effect meets the requirement and whether to adjust the existing tactile sense effect to generate a new tactile sense effect.

After the stylist designs one tactile sense effect, the designed tactile sense effect can be stored to the tactile sense effect library according to classification. Furthermore, if the stylist needs to handle a similar scenario or atmosphere in later work, the stylist can search the tactile sense effect in the tactile sense effect library by categories, or can screen out similar tactile sense effects from the tactile sense effect library according to scenario information, and then experience the found and screened out tactile according to the current scenario, and can perform on-demand adjustment on the tactile sense effect to obtain a desired tactile sense effect, instead of having to make another new tactile sense effect, so that the design efficiency of a tactile sense effect is improved.

After the tactile sense effect library of stylized classification and management is opened to users, archiving management can be performed on the existing tactile sense effect design achievements on the basis of a classification and screening mechanism of the tactile sense effect library. It is also convenient for design and development staff to search the existing design achievements, experience the effects, and reapply the effects in the future design work, so that the design cost can be reduced, and more users can find appropriate tactile sense effects through the style category labels and apply the tactile sense effects to products of more industries and fields, which is conductive to the generalization of the tactile sense effects.

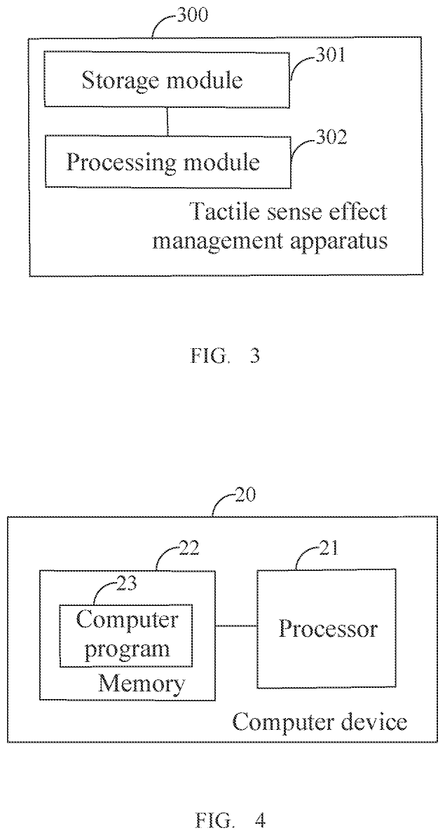

Referring to FIG. 3, one embodiment of the present invention further provides a tactile sense effect management apparatus 300. The tactile sense effect management apparatus 300 can include a storage module 301 and a processing module 302. The storage module 301 is configured to store tactile sense effect style information, the tactile sense effect style information including: a first basic style category corresponding to a first factor and a stylized basic element for providing a tactile sense effect under the first basic style category, wherein the first factor is an influencing factor used for generating tactile sense effects of different categories of styles; and the processing module 302 is configured to perform a reading operation on the tactile sense effect style information or performing a writing operation on the tactile sense effect style information.

FIG. 4 is a schematic diagram of a computer device provided by an embodiment of the present invention. As shown in FIG. 4, the computer device 20 of this embodiment includes a processor 21 and a memory 22. The memory 22 is configured to store computer programs 23 operable on the processor 21. The computer programs 23, when executed by the processor 21, implement the steps in the method embodiment of the present invention. In order to avoid repetition, the descriptions thereof will be omitted here. Or, the computer programs 23, when executed by the processor 21, realize functions of the various models/units in the apparatus embodiment of the present invention. In order to avoid repetition, the descriptions thereof will be omitted here.

The computer device 20 includes, but is not limited to, the processor 21 and the memory 22. Those skilled in the art can understand that FIG. 4 is only an example of the computer device 20, does not constitute a limitation to the computer device 20, and may include more or fewer components than those in the drawings, or combine some components or different components. For example, the computer device may further include an input/output device, a network access device, a bus, and the like.

The processor 21 may be a central processing unit (CPU), or may be other digital signal processors (DSPs), application specific integrated circuits (ASICs), field-programmable gate arrays (FPGAs), or other programmable logic devices, discrete gates, transistor logic devices, discrete hardware components, etc. The general-purpose processor may be a microprocessor or the processor may also be any conventional processor or the like.

The memory 22 may be an internal storage unit of the computer device 20, for example, a hard disk or an internal memory of the computer device 20. The memory 22 may also be an external storage device of the computer device 20, such as a plug-in hard disk equipped on the computer device 20, a smart media (SM) card, a secure digital (SD) card, a flash card, and the like. Further, the memory 22 may also include both an internal storage unit of the computer device 20 and an external storage device. The memory 22 is configured to store the computer programs 23 and other programs and data required by the computer device. The memory 22 may also be configured to temporarily store data that has been output or is to be output.

One embodiment of the present invention further provides an electronic device. The electronic device includes a memory configured to store computer programs, a processor configured to execute the computer programs, and a communication apparatus, wherein the computer programs, when executed by the processor, trigger the electronic device to perform any method in the embodiments of the present invention.

One embodiment of the present invention further provides a computer-readable storage medium. The computer-readable storage medium stores computer programs. The computer programs, when run on a computer, cause the computer to perform any method in the embodiments of the present invention.

In the several embodiments provided by the present invention, it should be understood that the disclosed device, apparatus and method may be implemented in other manners. For example, the apparatus embodiments described above are only schematic. For example, the division of the units is only a logical function division, and there may be another division method during actually implementation. For example, multiple units or components can be combined or integrated into another system, or some features can be ignored or not performed. On the other hand, the mutual coupling or direct coupling or communication connection shown or discussed can be indirect coupling or communication connection through some interfaces, apparatuses or units, and can be electrical, mechanical or other forms.

The units described as separate components may or may not be physically separated, and the components displayed as units may or may not be physical units, that is, they may be located in one place, or they may be distributed on multiple network units. Part or all of the units may be selected according to actual needs to achieve the objectives of the solutions of the embodiments.

In addition, all functional units in all the embodiments of the present invention can be integrated into one processing unit, or each unit can physically exist alone, or two or more units can be integrated in one unit. The above integrated units can be implemented in the form of hardware, or can be implemented in the form of hardware plus software functional units.

The above-mentioned integrated units implemented in the form of software functional units may be stored in one computer-readable storage medium. The above-mentioned software functional units are stored in one storage medium and include several instructions to cause a computer apparatus (which may be a personal computer, a server, or a network device, etc.) or a processor to execute part of the steps of the methods of the various embodiments of the present invention. The aforementioned storage media include: a U disk, a mobile hard disk, a read-only memory (ROM), a random access memory (RAM), a magnetic disk or an optical disk, and other media that can store program codes.

In the embodiments of the present invention, the terms “include”, “including”, or any other variation thereof are intended to cover a non-exclusive inclusion, so that a process, a method, an article, or a device that includes a list of elements includes those elements and further includes other elements not expressly listed or inherent to such a process, method, article, or device. Without more constraints, an element preceded by “includes a . . . ” does not preclude the existence of additional identical elements in the process, method, product, or device that includes the element.

The various embodiments in the present invention are described in a progressive way. For same or similar parts of the embodiments, mutual references can be made to the implementations. Each embodiment focuses on a difference from other embodiments. In particular, for the apparatus embodiment, since it is basically similar to the method embodiment, the description is relatively simple, and reference may be made to the partial description of the method embodiment for related parts.

Those of ordinary skill in the art may realize that the various units and algorithm steps in the embodiments of the present invention can be implemented by electronic hardware or a combination of computer software and electronic hardware. Whether these functions are executed by hardware or software depends on the specific application and design constraints of the technical solution. Professionals can use different methods for each specific application to implement the described functions, but such implementation should not be considered as going beyond the scope of the present invention.

Those skilled in the art can clearly understand that, for the convenience and simplicity of description, the specific working process of the above described systems, apparatuses and units can refer to the corresponding processes in the above method embodiments, and will not be repeated here.

The terms used in part of the implementations of the present invention are only used for explaining the specific embodiments of the present invention, but are not intended to limit the present invention. The implementation modes of the present invention are described above only. It should be noted that those of ordinary skill in the art can further make improvements without departing from the concept of the present invention. These improvements shall all fall within the protection scope of the present invention.

1. A tactile sense effect management method executed by an electronic device, comprising:
storing tactile sense effect style information, the tactile sense effect style information comprising: a first basic style category corresponding to a first factor and a stylized basic element for providing a tactile sense effect under the first basic style category;
wherein the first factor is an influencing factor used for generating tactile sense effects of different categories of styles; and
performing a reading operation on the tactile sense effect style information or performing a writing operation on the tactile sense effect style information;
outputting a tactile sense effect signal to drive the electronic device to generate corresponding tactile sense effect;
the first factor comprises at least one of a frequency, a duration, and an intensity.

2. The method according to claim 1, wherein the tactile sense effect style information further comprises other basic style categories corresponding to the first factor;
the storing tactile sense effect style information comprises:
storing various basic style categories corresponding to the first factor as one subset of a basic style category set in the tactile sense effect style information; and
storing stylized basic elements under various basic style categories corresponding to the first factor as one subset of a stylized basic element set in the tactile sense effect style information.

3. The method according to claim 1, wherein the tactile sense effect style information further comprises: a second basic style category corresponding to the first factor, one or more combined style categories obtained by correspondingly combining the first basic style category with the second basic style category in one or more ratios, and stylized basic elements under the combined style categories;
the storing tactile sense effect style information comprises:
storing the combined style categories obtained by combining at least two basic style categories corresponding to the first factor as one subset of a combined style category set in the tactile sense effect style information; and
storing stylized basic elements under the combined style categories obtained by combining at least two basic style categories corresponding to the first factor as one subset of a combined stylized basic element set in the tactile sense effect style information.

4. The method according to claim 1, wherein the performing a writing operation on the tactile sense effect style information comprises:
generating, according to configuration information of a third basic style category, a stylized basic element corresponding to the configuration information, the third basic style category being any basic style category in the tactile sense effect style information; and
storing the stylized basic element corresponding to the configuration information to the third basic style category.

5. The method according to claim 1, wherein the performing a reading operation on the tactile sense effect style information comprises:
acquiring, according to a screening condition, a stylized basic element in the tactile sense effect style information satisfying the screening condition;
wherein the screening condition comprises at least one of an identifier of the basic style category in the tactile sense effect style information, an identifier of the stylized basic element in the tactile sense effect style information, an identifier of the subset in the tactile sense effect style information, scenario information corresponding to the basic style category in the tactile sense effect style information, and scenario information corresponding to the stylized basic element in the tactile sense effect style information.

6. The method according to claim 5, wherein the screening condition comprises the scenario information;
the acquiring, according to a screening condition, a stylized basic element in the tactile sense effect style information satisfying the screening condition comprises:
acquiring, according to the scenario information in the screening condition, a first stylized basic element in the tactile sense effect style information; and
adjusting the first stylized basic element according to adjustment information of the first stylized basic element to obtain a second stylized basic element.

7. The method according to claim 5, wherein the screening condition comprises the scenario information;
the acquiring, according to a screening condition, a stylized basic element in the tactile sense effect style information satisfying the screening condition comprises:
acquiring, according to the scenario information in the screening condition, a first stylized basic element in the tactile sense effect style information; and
displaying a tactile sense effect according to the first stylized basic element.

8. (canceled)

9. (canceled)

10. (canceled)
